(19) United States
(12) Patent Application Publication
(10) Pub. No.: US 2004/0023622 A1
(43) Pub. Date: Feb. 5, 2004

(54) System and method for allocating power

(76) Inventors: Ramesh Mantha, Toronto (CA); Mark Frazer, Toronto (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/399,142

(22) PCT Filed: Aug. 30, 2001
(86) PCT No.: PCT/CA01/01229

(30) Foreign Application Priority Data
Sep. 14, 2000 (CA) 2,319,287
May 2, 2001 (CA) 2,346,214

(51) Int. Cl. H04B 7/00

(52) U.S. Cl. 455/115.1; 455/127.2

(57) ABSTRACT

The present invention provides a novel system, method and apparatus for allocating power between at least two communication services that share a common power output limit. Two communication services particularly suited for the present invention are voice services and data services transmitted on the downlink of a wireless network. An embodiment of the method includes determining the actual consumption of power on the voice channels of the wireless network during a given time period, and allocating substantially the same amount of power to the voice channels for the next time period, thus allowing for the allocation of the remaining amount of power to the data services, and thereby allowing, for example, increased modulation of the data services and thereby improve overall rates of data transfer and/or reliability of data transmission. Another embodiment of the method includes determining the power requirements for at least one communication service during the current time period; and, allocating a portion of the power budget to each communication services based on the determination.

### FIELD OF THE INVENTION

The present invention relates to a system, apparatus and method of providing enhanced features in a telecommunication system More specifically, the present invention relates to allocating a power budget between at least two communication services so that the entire power budget is substantially consumed.

### BACKGROUND OF THE INVENTION

Various forms of modern wireless communications systems are well known. For example, cellular wireless voice services are now widely deployed in industrialized nations, and technology improvements are expected to enhance and expand cellular wireless services and lead to further deployment.

Accompanying the increased deployment of wireless voice services is an increased demand for wireless data services, such as web-browsing, email and the like. The demand for both types of services reflects the well-identified trend towards the convergence of traditional voice and data services. In particular, wireless local loop (WLL) systems are expected to become a viable alternative to the wired local loop telephone services offered by the existing local telephone companies throughout North America However, in order to effectively compete with the existing local telephone companies, it is expected that WLL systems will need to provide both toll-quality voice services and high-speed data services.

Both mobile and WLL wireless services will have to provide any voice and data services within prescribed power budgets, as known to those of skill in the art For example, power-control features are usually incorporated into wireless base stations to ensure that services are offered within government p bed power budgets.

Various power management techniques are known. In IS-95, for example, it is known to rely on certain characteristics of voice telephone calls to assist in managing power output. Specifically, it is known that during a typical two-way voice telephone call over a wireless voice channel, each party will only speak, on average, for about one-half of the time that the channel is open (“Fifty-percent duty cycle”). This fifty-percent duty cycle can be used on the downlink (i.e. from the base station to the subscriber station), to reduce the amount of power allocated to the voice channels, and thus help keep the power output from the base station within the government-prescribed power budget. However, since the fifty-percent duty cycle is merely an average level of power consumption, over any given time-period the actual power consumed on a voice channel can exceed fifty-percent, thus requiring the allocation of additional power to voice channels in order to accommodate peak power usages.

Keeping the power output within the government-prescribed power budget in a combined voice and data system presents different challenges. In such systems, it is known to allocate a fixed level of power to the voice channels in substantially the same manner as described in the previous paragraph. Expressed in general terms, the allocation to the voice services is based, at least in part, on the fifty-percent duty cycle. The remainder of the power budget is then allocated to the data channels. On the whole, these power allocations remain fixed for a given base station. However, this method leads to the disadvantage that, when the actual amount of voice traffic over a given time period requires less than the level of allocated power, then the remaining power is wasted.

### SUMMARY OF THE INVENTION

It is an object of the present invention to provide a novel system, apparatus and method of allocating power that obviates or mitigates at least one of the above-identified disadvantages of the prior art.

In an aspect of the invention, there is provided a system for allocating a power budget between at least two communication services. The system includes one or more receiving-stations. In the aggregate, the receiving-stations are operable to receive at least two different communication services. For example, where the system has only one receiving station, then the one receiving station is operable to receive all of the communication services. Similarly, where the system has two or more receiving stations, then at least one of the receiving-stations is operable to receive one of the communication services, and the remaining receiving-stations are operable to receive the remaining communication services.

The system also comprises a transmitting-station for transmitting each of the services to the receiving-stations using a portion of the power budget for each of the services. The power budget is allocated between the portions according to an allocation criteria so that the power budget is substantially consumed.

The transmitting-station of the system is typically a wireless base station and the at least one receiving-station is a wireless subscriber station.

One of the services is a usually voice service, and the second service is usually a data service.

Typically, the allocation criteria used in the system includes the allocation of power to the voice service for a subsequent time period based on the actual power consumed by the voice service for a known time period. More particularly, the known time period is a current time period and the subsequent time period immediately follows said current time period.

It is believed that the time periods can be from about one millisecond to about forty milliseconds. It is also believed that the time periods can be from about two milliseconds to about thirty milliseconds. It is additionally believed that the time periods can also be from about five milliseconds to about twenty milliseconds. Furthermore, the time periods can also be from about seven milliseconds to about fifth milliseconds. In a presently preferred embodiment, the time periods are about ten milliseconds.

In another aspect of the invention, there is provided a method of allocating a power budget between communication services comprising the steps of:

predicting power requirements for at least one communication service during a future time period; and,

allocating a portion of the power budget to each of the communication services based on the prediction.

In particular, prediction step of the method includes determining actual power consumption for one of the at least one communication services during a current time period and the allocating step of the method includes allocating a portion equal to the actual power consumption to the one of the at least one communication services and allocating a remaining portion to a remainder of the at least one communication services.

In another aspect of the invention, there is provided a method of allocating a power budget between communication services comprising the steps of:

(i) for an initial time period, allocating the power budget between a plurality of communication services over a wireless link according to a predefined allocation;

(ii) for a current time period, establishing the communication services according to the allocation;

(iii) for the current time period, determining actual power consumption of at least one of the services;

(iv) for a future time period, allocating at least an equivalent amount of power as the actual power consumption determined at step (iii) to the at least one of the services;

(v) for the future time period, allocating a remaining amount of power to a remainder of the services, the remaining amount being an amount that was unallocated to the at least one of the services; and,

(vi) repeating steps (ii)-(v) for the future time period.

Another aspect of the invention includes determining the power requirements for at least one communication service during the current time period; and, allocating a portion of the power budget to each communication services based on the determination.

In another aspect of the invention, there is provided a method of allocating a power budget between communication services comprising the steps of:

(i) for an initial time period, allocating said power budget between a plurality of communication services over a wireless link according to a predefined allocation;

(ii) for a current time period, establishing said communication services according to said allocation;

(iii) for said current time period, determining actual power consumption of at least one of said services;

(iv) for said current time period, allocating at least an equivalent amount of power as said actual power consumption determined at step (iii) to said at least one of said services; repeating steps (ii)-(iv) for said future time period.

The present invention provides a novel system, method and apparatus for allocating power between at least two communication services that share a common power budget. Two communication services particularly suited for the present invention are voice services and data services transmitted on the downlink of a wireless network. An embodiment of the method includes determining the actual consumption of power on the voice channels of the wireless network during a given time period, and allocating substantially the same amount of power to the voice channels for the next time period. The remaining power is then allocated to the data services, and thereby allowing, for example, incased modulation of the data services and which can improve effective data rates and/or reliability of data transmission for that time period

### BRIEF DESCRIPTION OF THE DRAWINGS

Preferred embodiments of the present invention will now be described, by way of example only, with reference to the attached Figures, wherein:

FIG. 1 is a schematic representation of a system for allocating power in accordance with an embodiment of the invention;

FIG. 2 is a graph showing examples of power allocation according to the prior art; and,

FIG. 3 is a graph showing examples of actual power consumption according to the prior art

FIG. 4 is a flow-chart showing a method of allocating power in accordance with another embodiment of the invention;

FIG. 5 is a power-allocation pie-graph showing an exemplary initial allocation of power between channels;

FIG. 6 is the schematic representation of FIG. 1 showing an exemplary establishment of channels from the base station to subscriber stations;

FIG. 7 is the power-allocation pie-graph of FIG. 5 showing the actual power consumed by the voice channels during the initial time period;

FIG. 8 is a power-allocation pie-graph showing an exemplary allocation of power between channels for a time period subsequent to the time period shown in the pie-graph of FIG. 5;

FIG. 9 is a graph showing examples of power allocation for a number of time periods;

FIG. 10 is a graph showing examples of the actual power consumption during the time periods shown in FIG. 9; and,

FIG. 11 is a flow-chart showing a method of allocating power in accordance with another embodiment of the invention.

### DETAILED DESCRIPTION OF THE INVENTION

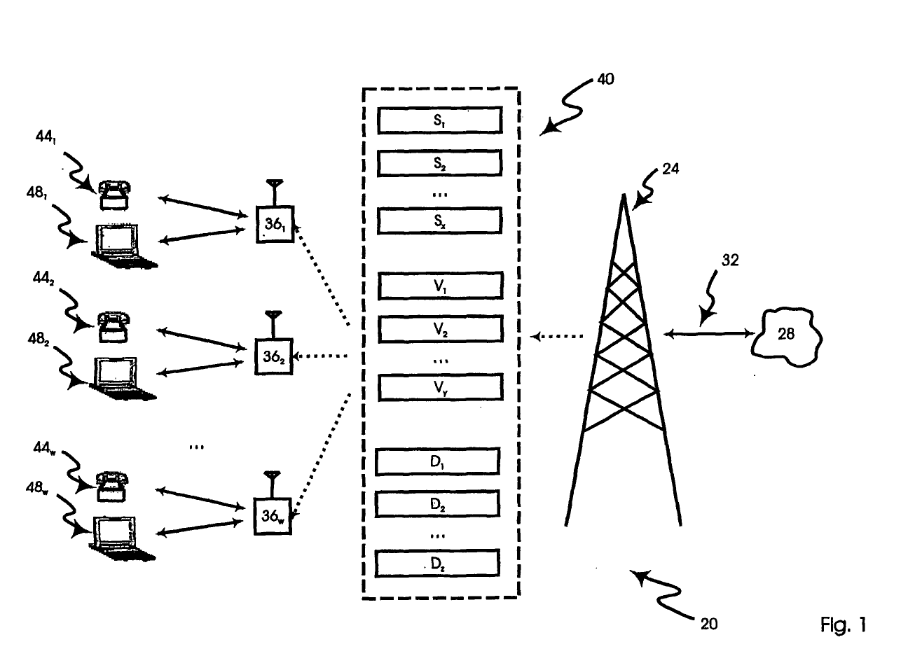

Referring now to FIG. 1, a system for allocating power between different services is indicated generally at 20. System 20 includes a wireless base station 24 that connects, through appropriate gateways, to a communication network 28 via a backhaul 32. Network 28 is typically the public switched telephone network (PSTN) combined with a packet switched data network, such as the Internet Backhaul 32 can be any known type of backhaul link between wireless base station 24 and network 28, such as a T1, T3, OC1 or a wireless microwave link, along with the appropriate and/or necessary gateways.

Base station 24 has a transmitter which is used for transmitting signaling information, voice service and data services to a plurality of subscriber stations 36₁, 36₂ . . . 36_{w} via a wireless downlink 40. (While not shown in FIG. 1, system 20 typically includes a wireless uplink for carrying traffic from subscriber stations 36 to base station 40.) Base station 24 also includes a processing unit for determining appropriate packaging (i.e. modulation and/or forward error correction (“PEC”)) for the voice and data services, and to transmit that packaging as signaling information.

Each subscriber station 36 has a receiver that is operable to receive, from base station 24, signaling information, voice services and data services. Each subscriber station 36 also includes a processing unit and is further operable to process (i.e. unpackage by demodulating or utilizing FEC) the received voice and data services according to instructions contained in signaling information received from base station 24. Accordingly, each subscriber station 36 is connected to a voice terminal 44 such as a plain old telephone system (POTS) telephone, and a data terminal 48, such as a laptop computer equipped with a network interface card (NIC). In general, it will be understood that each voice terminal 44 is operable to process voice telephone calls carried over the PSTN portion of network 28, while data terminal 48 is operable to process data applications carried over the packet switched data network portion of network 28.

In a presently preferred embodiment, each subscriber station 36 is fixed within a subscriber's premises and thus system 20 is part of a wireless local loop (WLL). However, it is also contemplated that the present invention is applicable to mobile, or nomadic, subscriber stations, such as web-enabled mobile cellular phones. It will thus be apparent that each voice terminal 44 and its respective data terminal 48 can be combined into a single intelligent device, such as a cellular phone with a built-in web browser or any other intelligent device that is operable to process both voice and data

In a presently preferred embodiment, wireless downlink 40 is based on any known digitally-based radio protocol, such as CDMA, OFDM, FDMA or TDMA. Downlink 40 also includes at least one signaling channel S₁, S₂ . . . Sₓ; at least one voice channel V₁, V₂ . . . V_{y}; and, at least one data channel D₁, D₂ . . . D. Signaling channels S contain signaling information, and are used to maintain each subscriber station 36 within system 20. Signaling channels S can include, for example, traditional IS-95 pilot channels and synch channels and the like, as needed to operate system 20. Using signaling channels S, base station 24 and subscriber stations 36 are operable to, in cooperation, dynamically establish one or more voice channels V and/or one or more data channels D to carry a respective voice and/or data service from base station 24 to one or more subscriber stations 36. Such establishment of channels can be performed, as needed, depending on whether a voice and/or data service is required by a subscriber respective to the particular subscriber station. Such negotiation for the establishing (or dismantling of voice channels V and/or data channels D can be performed over signaling channels S.

Thus, as used herein, “establishing” a channel includes the connection of a downlink service from base station 24 and one or more subscriber stations 36 using a voice channel V and/or a data channel D, as appropriate. Furthermore, the term “establishing” also includes the configuration of such channels over a given time period in accordance with QoS requirements and available system resources. For example, the “establishing” of a data channel D includes the modulation and FEC of the data channel D according to instructions received over signaling channels S. In the present embodiment, levels of modulation or FEC are influenced by the amount of power allocated to that data channel D and the reception-quality (i.e. measured as signal-to-noise ratio or SNR in a CDMA system) experienced by a receiving subscriber station 36.

Similarly, “dismantling” a channel means eliminating the connection and returning the radio resources of the dismantled channel to the pool of radio resources available for future establishment of channels over downlink 40.

One suitable structure for downlink 40 is discussed in Communication Structure With Channels Configured Responsive to Reception Quality filed in the Canadian Patent Office on May 30, 2000 and assigned Application No. 2,310,188 (“2,310,188”). Data channels D in the present invention can be analogous to the connectionless shared data channels discussed in 2,310,188 whereby one or more subscriber stations 36 can ‘listen’ to the data channel D and extract packets addressed to a respective subscriber station 36 from the data channel. In contrast, each voice channel V in the present invention can be analogous to the connection-like dedicated voice channels discussed in 2,310,188, whereby the channel behaves like a dedicated wired voice telephone connection.

However, other ways of structuring downlink 40 to provide combined voice and data services will occur to those of skill in the art and are within the scope of the invention. For example, one or more data channels D and/or voice channels V can be permanently established for communication of a data service and/or voice service, respectively, with a given subscriber station 36. Similarly, each subscriber station 36 within system 20 need not be capable of both voice service and data services, as long as at least one subscriber station 36 is for voice services and another one of the subscriber stations 36 is for data services. In general, it is to be understood that system 20 is operable to carry both voice services and data services over downlink 40, and that there are a variety of ways of structuring the channels that carry such services.

As is known to those of skill in the art, in the U.S.A. and other jurisdictions, service providers utilizing wireless links such as downlink 40 are limited to a specified range of bandwidth and to transmitting within a prescribed power budget (typically expressed as Effective Isotropic Radiated Power or EIRP) by base station 24. In the U.S.A., such limitations are usually prescribed by the Federal Communications Commission (FCC). As will be explained in greater detail below, in the present embodiment this prescribed power budget is allocated between signaling channels S, voice channels V and data channels D such that the entire power budget is substantially Before explaining the present embodiment further, however, it is useful to illustrate a prior art method of allocating a power budget between channels. According to a prior art method for allocating power in a system such as system 20, each set of signaling channels S, voice channels V and data channels D have a fixed amount of power allocated to each of these channels. Table I shows an example, over twenty-five time periods, of power allocations and actual power consumption according to the prior art.

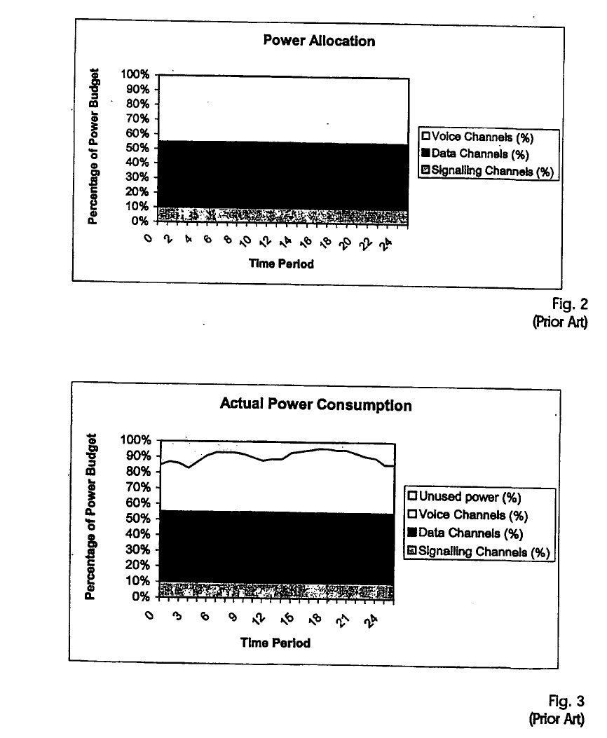

FIG. 2 shows a stacked bar-graph of the power allocation for the twenty-five time periods of Table I. The lower bar of FIG. 2 indicates that ten percent of the power budget is allocated to signaling channels S. The middle bar of FIG. 2 indicates that forty-five percent of the power budget is allocated to data channels D, and the top bar of FIG. 2 indicates that forty-five percent of the power budget is allocated to voice channels V.

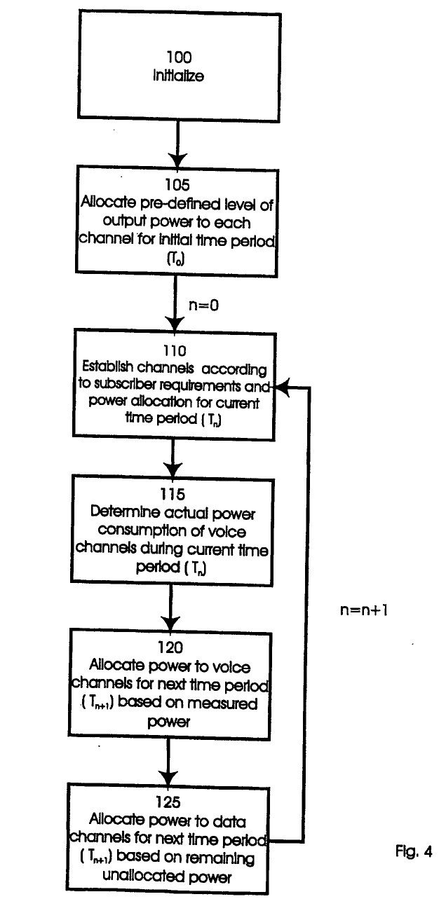

FIG. 3 shows a stacked bar-graph of actual power consumption according to the data in Table I. The lower bar of FIG. 2 indicates that ten percent of the power budget is actually consumed by signaling channels S. The second bar (above the lower bar) of FIG. 2 indicates that forty-five percent of the power budget is actually consumed by data channels D. However, the third bar (above of the second bar) indicates that the amount of the power budget actually consumed by voice channels V varies over time, thus leaving a portion of the power budget unused, as indicated by the top bar of FIG. 3. Overall, it can be seen from Table I, and FIGS. 2 and 3 that the amount of power actually used by signaling channels S and data channels D remains fixed, whereas the amount of power actually used by voice channels V fluctuates, resulting in unused power for at least some of the time periods.

However, in contrast to the prior art, in a present embodiment of the invention base station 24 is operable to allocate the power budget between channels in such a manner as to substantially utilize the entire budget, by utilizing at least a portion of the unused power shown in FIG. 3. In particular, base station 24 is operable to allocate a fixed amount of power to signaling channel S, which can be viewed as a fixed level of overhead power necessary to opera system 20. (It will be understood that the power allocation to signaling channels S can need to fluctuate depending on certain conditions, however, for purposes of explaining the present embodiment it will be assumed that the power allocated to signaling channels S will remain fixed.) Base station 24 is also operable to continually re-allocate power between voice channels V and data channels D according to predefined allocation criteria According to the present embodiment, the allocation criteria involves determining the amount of power actually consumed by the voice channels V during a present time period and allocating that amount of determined power to the voice channels V for a subsequent time period. The remaining amount of the power budget is then allocated the to data channels D.

A method for allocating power will now be discussed in accordance with another embodiment of the invention In order to assist in the explanation of the method, reference will be made to the foregoing discussion of system 20 and FIG. 1. Referring now to FIG. 4, a flowchart of the method of the present embodiment is shown At step 100, system 20 is initialized. Base station 24 and at least one subscriber station 36 are activated, and communications are initiated therebetween over downlink 40 via signaling channels S.

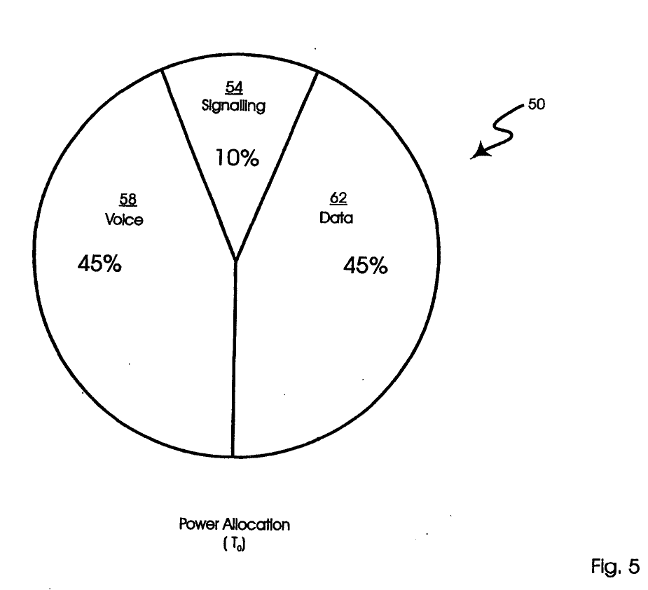

At step 105, predefined portions of the power budget are allocated between channels on downlink 40 for the initial time period. (Ibis initial time period is also referred to herein as To). FIG. 5 shows a power-allocation pie-graph 50 indicating an example of how the power budget assigned to base station 24 can be allocated Graph 50 represents the entire government-prescribed power budget assigned to system 20. Graph 50 shows that ten percent of the power budget is allocated to signaling channels S, which is represented by sector 54 of graph 50. Graph 50 also shows that forty-five percent the power budget is allocated to voice channels V, this percentage being resented by sector 58 of graph 50. Finally, graph 50 shows the remaining forty-five percent of the power budget is allocated to data channels D, this percentage being represented by sector 62 of graph 50. While graph 50 shows power allocations of ten percent, forty-five percent and forty-five percent for channels S, V, and D, respectively, it will be understood that any percentage can be assigned to each channel, as desired and appropriate for initiating the operation of system 20 at the initial time period (T₀).

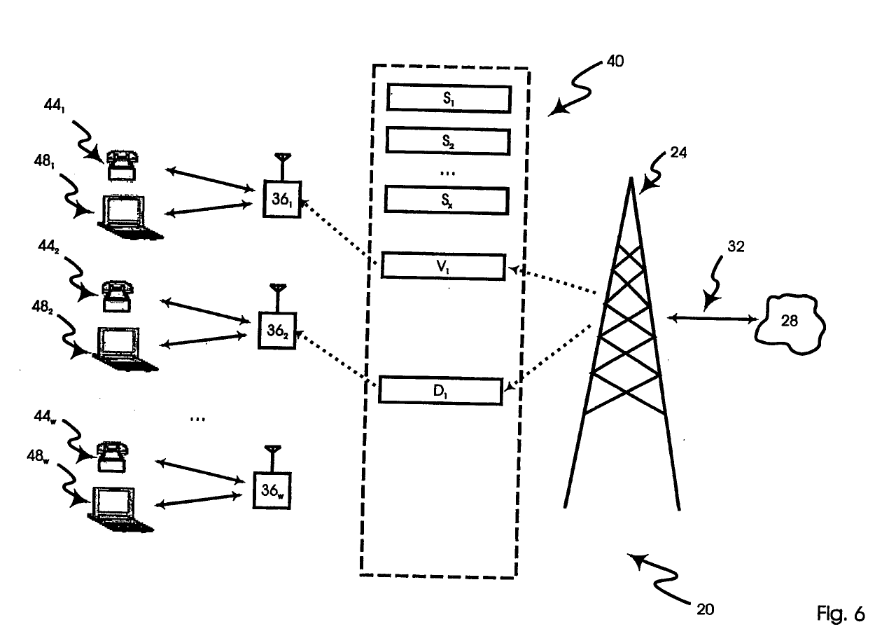

At step 110, voice channels V and data channels D are established according to subscriber requirements and the power allocations at step 105. An example of how step 110 can be implemented is shown in FIG. 6. It is to be understood that the example in FIG. 6 is simplified for the purposes of explaining the present embodiment, and that in practice, it is expected that several voice channels V and at least one data channel D (shared among many subscriber stations 36) will be active at any given time in system 20, as discussed in 2,310,188. As seen in FIG. 6, subscriber station 36₁ is shown to have initiated a voice service, thus establishing voice channel V₁ to carry the voice service from base station 24 to subscriber station 36₁. Similarly, subscriber station 362 is shown to have initiated a data service, thus establishing data channel D₁ to carry the data service from base station 24 to subscriber station 36₂. The establishment of voice channel V₁ and data channel D₁ is also made in accordance with the power allocations at step 105. Accordingly, voice channel V₁ is allocated forty-five percent of the power-budget, and data channel D₁ is also allocated forty-five percent of the power-budget. It is presently preferred that the allocation of power to data channel D₁ is then used by base station 24 to transmit data channel D₁ at the highest possible rate of modulation and/or highest possible rate of FEC to ensure the highest possible effective bit-rate to subscriber station 36₂.

Referring again to FIG. 4, the method then advances to step 115, where the percentage of the power budget that is actually consumed by voice channel V₁ is determined for a current time period (Tₙ, n=0). It is presently preferred that the duration for each time period be about ten ms (Tₙ.10 ms), ten ms being the amount of time occupied by one fame of transferred data in the proposed 3GPP standard. However, other time periods will occur to those of skill in the art and can be selected according to desired system parameters. For example, the inventors believe that where one frame of transmitted data is ten ms, an-appropriate time period can be from about one frame to about four frames.

It is presently preferred that this amount of power is determined by examining incoming voice traffic over backhaul 32, for, as is known to those of skill in the art, certain types of encoded voice packets will either include reduced-packets (which indicate silence, often referred to as DTX packets in the emerging 3GPP standard, or will include full packets (containing voice coding). By monitoring reduced-packets for each voice channel V, it can be determined how much power is actually consumed by a given voice channel V during a corresponding time period. While not presently preferred, other means of determining the amount of power actually consumed during a desired time period are also within the scope of the invention, such as directly measuring the amount of power radiated by base station 24.

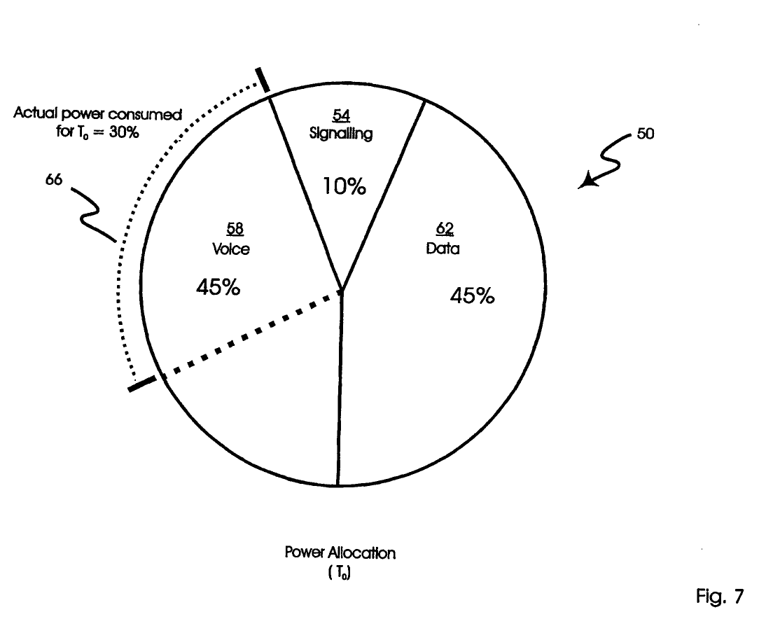

FIG. 7 shows an example of the voice power actually consumed, as determined during the initial time period To at step 115. This actual amount of power is represented on FIG. 7 as sector 66, which indicates that thirty-percent of the power budget is actually consumed by voice channel V₁ during the current time period (Tₙ, n=0).

The method then advances to step 120, at which point the amount of power determined at step 115 is allocated to voice channel V₁ for the next time period (Tₙ₊₁, n=0). The allocation at step 120 can also include some additional amount of power to provide a safety margin in the event that the amount of power consumed during the next time period is actually greater than the amount allocated. Thus, in order to preserve a desired level of QoS for voice channel V₁, it is presently preferred to allocate an additional predetermined amount of power, (in the present embodiment an exemplary margin of five percent is used), for use by voice channels V during the next time period, should the amount of power actually consumed by voice channels V during the next time period exceed the amount determined at step 115.

The method then advances to step 125, where the remaining power available to base station 24 (i.e. the power that was not allocated to voice channels V at step 120 and otherwise reserved for signaling channels S) is allocated to data channels D.

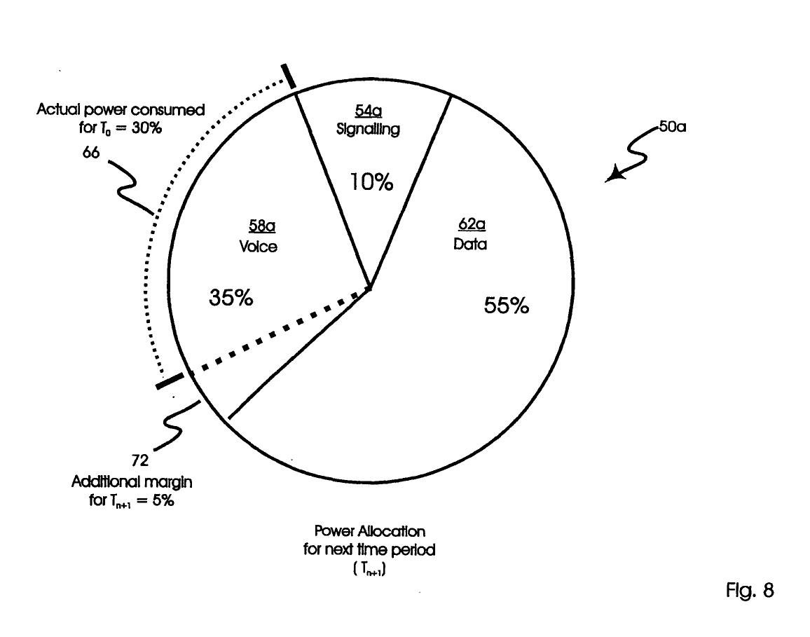

FIG. 8 shows a power-allocation pie-graph 50a indicating an example of how the total amount of power assigned to base station 24 is allocated for the next time period Tₙ₊₁, n=0), as a result of the allocations at steps 120 and 125. Graph 50a shows the same percentage of the power-budget is allocated to signaling channels S as was allocated in graph 50 of FIG. 5. This percentage is indicated as sector 54a of graph SOL However, while the size of sector 54a remains the same size as sector 54 of graph 50, the remaining sectors of graph 50a differ from the sectors of graph 50. Thus, graph 50a shows a power allocation that reflects the allocation to voice channels V made at step 120, indicated as sector 58a, which is thirty-five percent of the power budget. As previously discussed, thirty-percent of the allocation is derived from the actual amount of power consumed during To, plus an additional margin of five percent- this margin being indicated at 72 of FIG. 8. Thus, sector 58a represents the percentage of the power-budget allocated for the next time period (Tₙ₊₁, n=0) to voice channels V.

Finally, graph 50a shows the remaining percentage of the power-budget that is allocated to data channels D, which reflects the allocation made at step 125. This power allocation to data channels D is indicated as sector 62a of graph 50a As previously discussed, the allocation of fifty-five percent to sector 62a reflects the amount of power not allocated to signaling channels S and voice channels 58a Thus, sector 62a rests the percentage of the power budget allocated for the next time period (Tₙ₊₁, n=0) to data channels D.

At this point the method returns to step 110, during which the time period advances (n=n+1). Voice channels V and data channels D are established according to the demands of subscriber stations 36, and according to the power allocations shown in FIG. 8. It will now be apparent to those of skill in the art that the additional power now allocated to data channels D can be used in a variety of ways to improve the likelihood of successful transmission, and/or the effective rate of data transfer, of data transmitted over data channels D to respective subscriber stations 36. For example, the additional power available to data channels D can be utilized to increase the modulation order and/or increase C rates thereby increasing overall data transmission rates and/or overcoming poor reception-qualities.

The method then continuously cycles through steps 110 to 125, thus continually re-allocating power to voice channels V and data channels-D in such a manner to ensure that the power budget is divided between voice channels V and data channels D and is thus substantially utilized.

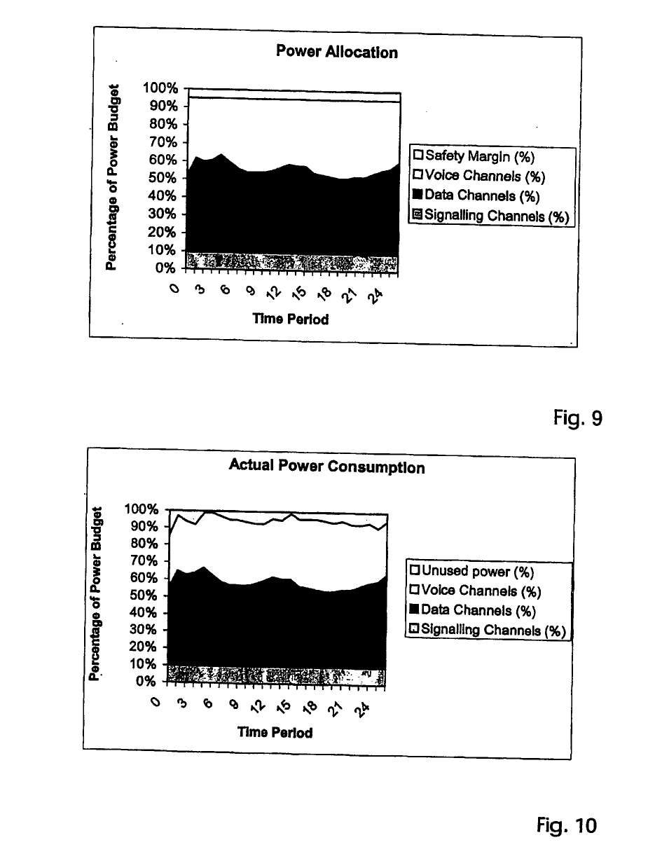

In order to further assist in the understanding of the foregoing, Table II lists an exemplary set of allocated power and actual power over twenty-five time periods when the method cycles through steps 110 to 125, wherein T₀ and T₁ are based on the foregoing discussion. FIG. 9 and FIG. 10 attached hereto are graphs of the data in Table II showing power allocation and actual power consumption, respectively. It can be seen that that the formats of Table I. FIG. 2 and FIG. 3 correspond to the formats of Table II, FIG. 9 and FIG. 10, respectively. When Table II (and its associated graphs) is compared with Table I (and its associated graphs), it can be seen that the power budget in Table II is substantially allocated between both voice channels V and data channels D, whereas the power budgeting in Table I (the prior art) shows a larger amount of unused power.

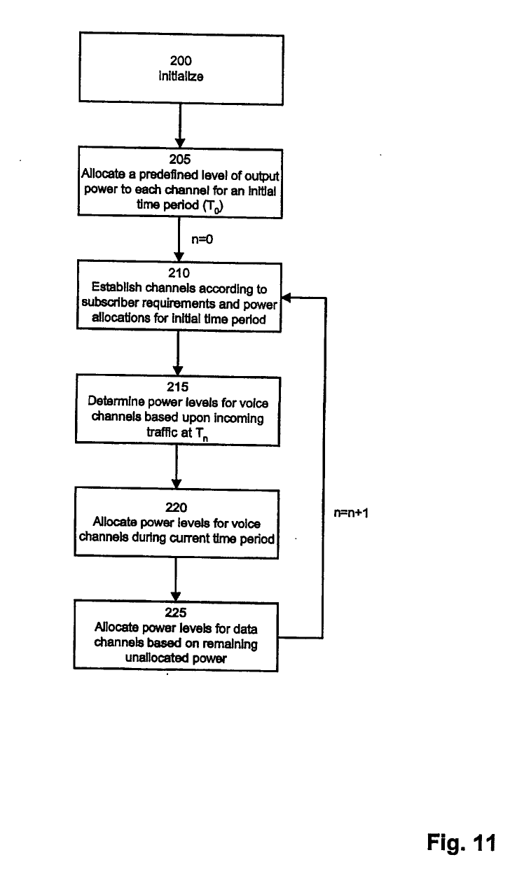

An additional method for allocating power will now be discussed in accordance with another embodiment of the invention. This method refers to dynamically adjusting a power budget “on the fly,” that is to say, within the current time period. In order to assist in the explanation of the method, reference will be made to the foregoing discussion of system 20 and FIG. 1. Referring now to FIG. 11, a flowchart of the method of the present embodiment is shown. At step 200, system 20 is initialized Base station 24 and at least one subscriber station 36 are activated, and communications are initiated therebetween over downlink 40 via signaling channels S.

At step 205, predefined portions of the power budget are allocated between the active voice and data channels on downlink 40 for the initial time period. (Ibis initial time period is also referred to herein as To). It is presently contemplated that channel setup occurs in substantially the same manner as the previously described step 105 of FIG. 4. It is also presently contemplated that, if desired, step 205 could be omitted or varied, as desired.

At step 210, voice channels V and data channels D are established according to subscriber requirements and the power allocations at step 205. It is presently contemplated that the establishment of voice channels V and data channels D occurs in substantially the same manner as the previously described step 110 of FIG. 4. It is also presently contemplated that, if desired, step 210 could be omitted or varied, as desired.

The method then advances to step 215, where the required percentage of the power budget that is actually required for each voice channel V at the current time period (Tₙ) is determined. It is presently preferred that the duration for each time period be about ten ms (Tₛ.10 ms), ten ms being the amount of time occupied by one frame transmitted using the proposed 3GPP standard However, other time periods will occur to those of skill in the art and can be selected according to desired and/or required system parameters.

It is presently preferred that this required amount of power is determined by examining incoming voice traffic over backhaul 32, for, as is known to those of skill in the art, certain types of encoded voice packets will either include reduced-packets (which indicate silence, often referred to as DTX packets in the emerging 3GPP standard), or will include full packets (containing voice coding). By monitoring incoming packets for each voice channel V, it can be determined how much power is actually required for each given voice channel V for the current time period. As each incoming packet is analyzed by the processing unit of base station 24, the processor can determine the amount of power required “on the fly”—quickly enough as to be undetectable to the human ear. Other methods of determining power requirements will occur to those of skill in the art and are within the scope of the invention.

The method then advances to step 220, at which point the amount of power determined to be necessary at step 215 is allocated to voice channel V₁ for the current time period (Tₙ). The allocation at step 220 can also include some additional amount of power to provide a safety margin.

The method then advances to step 225, where the remaining power available to base station 24 (i.e. the power that was not allocated to voice channels V at step 220 and otherwise reserved for signaling channels S) is allocated to data channels D.

Referring back to FIG. 11, at this point the method returns to step 210, during which the time period advances (n=n+1). Voice channels V and data channels D are established according to the demands of subscriber stations 36, and according to the power allocations made at steps 220 and 225. It will now be apparent to those of skill in the art that the additional power now allocated to data channels D can be used in a variety of ways to improve the likelihood of successful transmission, and/or the effective rate of data transfer, of data transmitted over data channels D to respective subscriber stations 36. For example, the additional power available to data channels D can be utilized to increase the modulation order and/or increase FEC rates thereby increasing overall data transmission rates and/or overcoming poor reception-qualities.

The method then continuously cycles through steps 210 to 225, thus continually re-allocating power to voice channels V and data channels D in such a manner to ensure that the power budget is divided between voice channels V and data channels D and is thus substantially utilized.

While the embodiments discussed herein are directed to specific implementations of the invention, it will be understood that combinations, sub-sets and variations of the embodiments are within the scope of the invention. For example, the foregoing embodiments discuss the allocation of a fixed amount power to three different types of communication services, yet the present invention is applicable to any system wherein a limited amount of power is to be allocated between at least two different services.

Other variations of the invention are also contemplated. For instance, those of skill in the art will recognize that the method shown in FIG. 4 uses a Markov model to predict future voice activity—but other criteria and/or operations and/or models can be used to substantially allocate a power budget between different communication services. For example, more sophisticated modeling may involve analyzing a history of voice activity to predict future voice activity, rather than simply using the current level of voice activity to predict future voice activity. Similarly, the prediction can be made for any future time period that can be reasonably predicted, and accordingly, the allocation of power can be for more than one time period subsequent to the time period when the prediction occurs. For example, it can be desired to actually allocate the power budget for two time periods after the period when the prediction is made, in order to use the next time period to set-up the allocated power and corresponding changes to modulation and forward-error-correction in the base station and the subscriber stations.

While presently more difficult to implement and not presently preferred, it can be also desired to allocate a remaining portion of the power budget to voice services after allocating an initial portion of the power budget to data services based on predicted usages of the data services. While data service usage can be more difficult to predict than voice service usage, it is to be understood that the present invention has general application to allocating power between more than two services, where at least one of the services has characteristics that allow some degree of prediction through statistics or other means. For example, MPEG video conferencing and FP Casters are types of data service that have characteristics that allow for some level of prediction. Thus, for example, the present invention can be applied to the allocation of power between an MPEG video conference and a traditional data service, such as web-browsing.

Allocation criteria can also be influenced by different business models and pricing schemes. For example, subscribers at different subscriber stations may pay different fees for different levels of service, such as desired voice quality or effective data rates. Thus, for example, where one subscriber pays for highly quality voice service (e.g. 32 kb/s), then the margin allocated to the voice service may be higher than a subscriber who pays for lower quality voice service (e.g. 8 kb/s).

While the embodiments herein are directed to allocating power on a wireless downlink, it is contemplated that the present invention can be modified for use on other types of transmissions of more than one type of service using a given power budget For instance, on an uplink from a subscriber station to a base station, the base station will typically assign a power budget to the subscriber station. When such an uplink is carrying both a voice and a data service, the present invention can be used to allow the subscriber station to allocate power between the voice and data services, and thereby increase effective data rates.

While the embodiments discussed herein refer to the allocation of an additional safety margin of power to voice channels for the next time period, it is to be understood that such a margin may not be necessary or can be chosen based on system QoS requirements. More specifically, the inventor has determined that the likelihood of large fluctuations in overall power requirements for all voice channels decreases as the number of active voice channels increases. In other words, where a large number of voice channels V are active during a given time period Tₙ, then the amount of margin allocated to all voice channels V can be reduced and/or eliminated, as the amount of change of power between time periods Tₙ will be less for a large number of voice channels V. Thus, the margin level, if any, can be chosen based on the number of voice channels V that are active during any given time period.

The amount of margin can also be chosen using other or additional criteria For example, where system 20 is on a boundary of network coverage (i.e. not adjacent to other base stations 24), then interference with adjacent base stations will be less significant and momentarily exceeding the power-budget may be permissible. Other criteria for choosing the amount of safety margin, if any, are within the scope of the -invention.

It is contemplated that the method described in FIG. 11 could be combined with the method described in FIG. 4, so that system 20 uses a combination of predictive and “on the fly,” power allocation criteria.

It is further contemplated that other criteria for power allocation could also be used and/or combined with the methods described above. An example of another criterion would be a restriction that would limit the power on the D channel for uses that subscribe to the “economy” service. Another example of a criterion used for power allocation would be to limit certain types of traffic by the time of day. A service provider could encourage certain types of behavior such as making the maxim power rate for the D channel higher during the evening (when the service provider requires less capacity for business calls) and lower during the day (during prime business hours). Other allocation criteria will occur to those of skill in the art.

The present invention provides a novel, system, method and apparatus for allocating power between at least two communication services that share a common power budget. The invention allows the monitoring of actual power consumption on one communication service, such as a voice service, and predicts the future consumption of that service and allocates power to the voice service based on the prediction. The remainder of the power-budget is then made available to a second communication service, such as a data service. The invention is particularly useful in combined voice and data systems to ensure that power can be used by voice services and data services on an as-needed and/or as-available basis thus increasing the amount and/or reliability of data transmissions from base stations to subscriber stations. When used in a CDMA system, the invention is also a useful way to continuously reallocate system resources among different types of services without having to rellocate CDMA channels among those different types of services.

The above-described embodiments of the invention are intended to be examples of the present invention and alterations and modifications may be effected thereto, by those of skill in the art, without departing from the scope of the invention which is defined solely by the claims appended hereto.

TABLE I
(Prior Art)

| | Power Allocation | | | Actual Power Consumption | | | |
|---|---|---|---|---|---|---|---|
| | Signaling | Data | Voice | Signaling | Data | Voice | |
| Time | Channels | Channels | Channels | Channels | Channels | Channels | Unused |
| period (Tn) | (%) | (%) | (%) | (%) | (%) | (%) | power (%) |
| 0 | 10 | 45 | 45 | 10 | 45 | 30 | 15 |
| 1 | 10 | 45 | 45 | 10 | 45 | 32 | |
| 2 | 10 | 45 | 45 | 10 | 45 | 31 | |
| 3 | 10 | 45 | 45 | 10 | 45 | 28 | |
| 4 | 10 | 45 | 45 | 10 | 45 | 32 | |
| 5 | 10 | 45 | 45 | 10 | 45 | 36 | |
| 6 | 10 | 45 | 45 | 10 | 45 | 38 | |
| 7 | 10 | 45 | 45 | 10 | 45 | 38 | |
| 8 | 10 | 45 | 45 | 10 | 45 | 38 | |
| 9 | 10 | 45 | 45 | 10 | 45 | 37 | |
| 10 | 10 | 45 | 45 | 10 | 45 | 35 | |
| 11 | 10 | 45 | 45 | 10 | 45 | 33 | |
| 12 | 10 | 45 | 45 | 10 | 45 | 34 | |
| 13 | 10 | 45 | 45 | 10 | 45 | 34 | |
| 14 | 10 | 45 | 45 | 10 | 45 | 38 | |
| 15 | 10 | 45 | 45 | 10 | 45 | 39 | |
| 16 | 10 | 45 | 45 | 10 | 45 | 40 | |
| 17 | 10 | 45 | 45 | 10 | 45 | 41 | |
| 18 | 10 | 45 | 45 | 10 | 45 | 41 | |
| 19 | 10 | 45 | 45 | 10 | 45 | 40 | |
| 20 | 10 | 45 | 45 | 10 | 45 | 40 | |
| 21 | 10 | 45 | 45 | 10 | 45 | 38 | |
| 22 | 10 | 45 | 45 | 10 | 45 | 36 | |
| 23 | 10 | 45 | 45 | 10 | 45 | 35 | |
| 24 | 10 | 45 | 45 | 10 | 45 | 31 | |
| 25 | 10 | 45 | 45 | 10 | 45 | 31 | |

TABLE II

| | Power Allocation | | | | Actual Power Consumption | | | |
|---|---|---|---|---|---|---|---|---|
| Time | Signaling | Data | Voice | Safety | Signaling | Data | Voice | Unused |
| period | Channels | Channels | Channels | Margin | Channels | Channels | Channels | power |
| (Tn) | (%) | (%) | (%) | (%) | (%) | (%) | (%) | (%) |
| 0 | 10 | 45 | 45 | 5 | 10 | 45 | 30 | 15 |
| 1 | 10 | 55 | 35 | 5 | 10 | 55 | 32 | 3 |
| 2 | 10 | 53 | 37 | 5 | 10 | 53 | 31 | 6 |
| 3 | 10 | 54 | 36 | 5 | 10 | 54 | 28 | 8 |
| 4 | 10 | 57 | 33 | 5 | 10 | 57 | 32 | 1 |
| 5 | 10 | 53 | 37 | 5 | 10 | 53 | 36 | 1 |
| 6 | 10 | 49 | 41 | 5 | 10 | 49 | 38 | 3 |
| 7 | 10 | 47 | 43 | 5 | 10 | 47 | 38 | 5 |
| 8 | 10 | 47 | 43 | 5 | 10 | 47 | 38 | 5 |
| 9 | 10 | 47 | 43 | 5 | 10 | 47 | 37 | 6 |
| 10 | 10 | 48 | 42 | 5 | 10 | 48 | 35 | 7 |
| 11 | 10 | 50 | 40 | 5 | 10 | 50 | 33 | 7 |
| 12 | 10 | 52 | 38 | 5 | 10 | 52 | 34 | 4 |
| 13 | 10 | 51 | 39 | 5 | 10 | 51 | 34 | 5 |
| 14 | 10 | 51 | 39 | 5 | 10 | 51 | 38 | 1 |
| 15 | 10 | 47 | 43 | 5 | 10 | 47 | 39 | 4 |
| 16 | 10 | 46 | 44 | 5 | 10 | 46 | 40 | 4 |
| 17 | 10 | 45 | 45 | 5 | 10 | 45 | 41 | 4 |
| 18 | 10 | 44 | 46 | 5 | 10 | 44 | 41 | 5 |
| 19 | 10 | 44 | 46 | 5 | 10 | 44 | 40 | 6 |
| 20 | 10 | 45 | 45 | 5 | 10 | 45 | 40 | 5 |
| 21 | 10 | 45 | 45 | 5 | 10 | 45 | 38 | 7 |
| 22 | 10 | 47 | 47 | 5 | 10 | 47 | 36 | 7 |
| 23 | 10 | 49 | 49 | 5 | 10 | 49 | 35 | 6 |
| 24 | 10 | 50 | 50 | 5 | 10 | 50 | 31 | 9 |
| 25 | 10 | 54 | 54 | 5 | 10 | 54 | 31 | 5 |

We claim:

1. A system for allocating a power budget between at least two communication services comprising:
at least one receiving-station being, in the aggregate, operable to receive at least two different communication services; and,
a transmitting-station for transmitting each of said services to at least one of said receiving-stations using a portion of said power budget, said portions being allocated according to an allocation criteria such that said power budget is substantially consumed.

2. The system according to claim 1 wherein said transmitting-station is a base station and said receiving-station is a subscriber station.

3. The system according to claim 2 having a plurality of subscriber stations and wherein one of said subscriber stations is operable to receive one of said services and another of said subscriber stations is operable to receive a second one of said services.

4. The system according to claim 2 having one subscriber station and wherein said subscriber station is operable to receive said at least two communication services.

5. The system according to claim 1 wherein said transmitting-station is a subscriber station and said receiving-station is a base station.

6. The system according to claims 1-5 wherein one of said services is a voice service.

7. The system according to claims 16 wherein one of said services is a data service.

8. The system according to claim 6 wherein said allocation criteria includes the allocation of power to said voice service for a subsequent time period based on the actual power consumed by said voice service for a known time period.

9. The system according to claim 8 wherein said known time period is a current time period and said subsequent time period immediately follows said current time period.

10. The system according to claims 8 and 9 wherein said time periods are from about one millisecond to about forty milliseconds.

11. The system according to claim 10 wherein said time periods are from about two milliseconds to about thirty milliseconds.

12. The system according to claim 10 wherein said time periods are from about five milliseconds to about twenty milliseconds.

13. The system according to claim 10 wherein said time periods are from about seven milliseconds to about fifteen milliseconds.

14. The system according to claim 10 wherein said time periods are about ten milliseconds.

15. The system according to claim 8 wherein said allocation criteria includes allocating a remaining portion of said power budget to a data service for a subsequent time period based on the amount of power that was not allocated to said voice services.

16. The system according to claim 1 wherein said allocation criteria includes, for one of said at least one communication services for a future time period, allocating an equivalent to an amount of power that was actually consumed by said communication service during a known time period and allocating a remainder of said power budget to a remainder of said communication services.

17. A method of allocating a power budget between communication services comprising the steps of:
predicting power requirements for at least one communication service during a future time period; and,
allocating a portion of said power budget to each of said communication services based on said prediction.

18. The method according to claim 16 wherein said prediction step includes determining actual power consumption for one of said at least one communication services during a current time period and said allocating step includes allocating a portion equal to said actual power consumption to said one of said at least one communication services and allocating a remaining portion to a remainder of said at least one communication services.

19. A method of allocating a power budget between communication services comprising the steps of:
a. for an initial time period, allocating said power budget between a plurality of communication services over a wireless link according to a predefined allocation;
b. for a current time period, establishing said communication services according to said allocation;
c. for said current time period, determining actual power consumption of at least one of said services;
d. for a future time period, allocating at least an equivalent amount of power as said actual power consumption determined at step (iii) to said at least one of said services;
e. for said future time period, allocating a remaining amount of power to a remainder of said services, said remaining amount being an amount that was unallocated to said at least one of said services; and,
f. repeating steps (ii)-(v) for said future time period.

20. A system for allocating a power budget between at least two services comprising:
a first subscriber station operable to receive at least a voice service;
an additional subscriber station operable to receive at least a data service;
a base station for transmitting said voice service to said first subscriber-station using a portion of said power budget while transmitting said data service to said additional subscriber station using a remainder of said power budget, said portion allocated based on an actual amount of power consumed during a previous time period.

21. A subscriber station comprising:
a receiver for a signaling channel, a voice channel and a data channel;
processing means connected to said receiver for adjusting demodulation and forward error correction rates of packets received over said voice channel and said data channel during successive time periods, said adjusting based on instructions received over said signaling channel that correspond to power allocations made by a base station transmitting said channels.

22. A base station comprising:
a gateway for receiving voice packets and data packets from a network;
a processing unit for allocating a portion of a power budget for smiting voice packets during a current time period based on actual power consumed for transmitting voice packets during a previous time period, said processing unit for further allocating a remainder of said power budget for transmitting data packets during said current time period; and,
a transmitter for transmitting said packets to intended subscriber stations via a downlink according to said allocations.

23. A method of allocating a power budget between communication services comprising the steps of:
determining power requirements for at least one communication service during said current time period; and,
allocating a portion of said power budget to each of said communication services based on said determination.

24. The method according to claim 23 wherein said determination step includes determining actual power consumption for one of said at least one communication services during a current time period and said allocating step includes allocating a potion equal to said actual power consumption to said one of said at least one communication services and allocating a remaining portion to a remainder of said at least one communication services.

25. A method of allocating a power budget between communication services comprising the steps of:
a. for an initial time period, allocating said power budget between a plurality of communication services over a wireless link according to a all predefined allocation;
b. for a current time period, establishing said communication services according to said allocation;
c. for said current time period, determining actual power consumption of at least one of said services;
d. for said current time period, allocating at least an equivalent amount of power as said actual power consumption determined at step (c) to said at least one of said services;
e. repeating steps (a)-(d) for said future time period.

26. A system for allocating a power budget between at least two services comprising:
a first subscriber station operable to receive at least a voice service; an additional subscriber station operable to receive at least a data service;
